(19) United States
(12) Patent Application Publication
(10) Pub. No.: US 2005/0011291 A1
(43) Pub. Date: Jan. 20, 2005

(54) Electric actuator

(75) Inventors: Shigekazu Nagai, Adachi-ku (JP); Ryuichi Masui, Iwai-shi (JP); Masaki Miyahara, Moriya-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Kabushiki Kaisha, Tokyo (JP)

(21) Appl. No.: 10/883,770

(22) Filed: Jul. 6, 2004

(30) Foreign Application Priority Data
Jul. 15, 2003 (JP) 2003-274928

(51) Int. Cl. F16H 25/20

(52) U.S. Cl. 74/89.32

(57) ABSTRACT

An electric actuator comprises a feed screw shaft which allows a piston and a piston rod to make rectilinear reciprocating motion by converting the rotary driving force of a rotary driving source into rectilinear motion to transmit to the piston and the piston rod, a rod cover which separated from a housing at a predetermined distance in the axial direction, and a pair of guide rods each of which has one end connected to the rod cover and the other end connected to the housing and which are parallel to one another with the piston intervening therebetween to guide the piston.

### BACKGROUND OF THE INVENTION

1. Field of the Invention

The present invention relates to an electric actuator capable of making rectilinear reciprocating motion of a displaceable member under a rotary driving action of a rotary driving source.

2. Description of the Related Art

A transport mechanism such as an actuator has been conventionally used, for example, in order to transport a workpiece.

A conventional electric actuator is shown in FIGS. 20 and 21 (see, for example, Japanese Laid-Open Patent Publication No. 11-30234).

The conventional electric actuator 1 includes a slider 4 which is displaceable along a recess 3 of a frame 2, and a screw shaft 6 which is driven by an unillustrated motor and which is screwed to a nut member 5 that is detachable with respect to the slider 4. Screw shaft support members 7a, 7b, which rotatably support the screw shaft 6, are provided at both ends of the screw shaft 6. The screw shaft support members 7a, 7b are attached to an upper surface 8 of the frame 2.

The rigidity of the conventional electric actuator 1, as described above, is secured by the frame 2 which is formed of, for example, a metal material such as aluminum. If, however, the frame 2 is removed from the electric actuator 1 to reduce the number of parts and to lighten the weight, it will become difficult to secure the rigidity of the electric actuator 1.

### SUMMARY OF THE INVENTION

A general object of the present invention is to provide an electric actuator which makes it possible to reduce the number of parts and lighten the weight without the need for a frame.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 shows a perspective view illustrating an electric actuator according to an embodiment of the present invention;

FIG. 2 shows, with partial cutaway, a plan view illustrating the electric actuator shown in FIG. 1;

FIG. 3 shows a longitudinal sectional view taken in the axial direction of the electric actuator shown in FIG. 1;

FIG. 4 shows an exploded perspective view illustrating a bearing, a spacer, and a fastening member to be installed to an end of a feed screw shaft for constructing the electric actuator shown in FIG. 1;

FIG. 5 shows a partial vertical sectional view illustrating a situation in which the load applied to a piston is absorbed by a pair of guide rods;

FIG. 6 shows a side view comparing the electric actuator shown in FIG. 1 with a conventional electric actuator having a rectangular shape;

FIG. 7 shows, with partial cutaway, a perspective view illustrating a situation in which the piston is formed with resin while inserting a cylindrical member;

FIG. 8 shows, with partial cutaway, a plan view illustrating another embodiment without any coupling members;

FIG. 9 shows a perspective view illustrating a state in which the electric actuator of the rod type shown in FIG. 1 is changed to an electric actuator of the slide table type;

FIG. 10 shows a perspective view illustrating a state in which a housing and a rod cover shown in FIG. 1 are formed with stacked steel plates;

FIG. 11 shows a perspective view illustrating an electric actuator according to another embodiment to which a cover member is installed;

FIG. 12 shows a vertical sectional view taken along a line XII-XII shown in FIG. 11;

FIG. 13 shows a perspective view illustrating an electric actuator according to still another embodiment to which a cover member having an opening is installed;

FIG. 14 shows a vertical sectional view taken along a line XIV-XIV shown in FIG. 13;

FIG. 15 shows a perspective view illustrating an electric actuator according to still another embodiment to which a pair of sensor rails is installed;

FIG. 16 shows a vertical sectional view taken along a line XVI-XVI shown in FIG. 15;

FIG. 17 shows a perspective view illustrating an electric actuator according to still another embodiment which has a rectangular box-shaped frame;

FIG. 18 shows a longitudinal sectional view taken in the axial direction of the electric actuator shown in FIG. 17;

FIG. 19 shows a vertical sectional view taken along a line XIX-XIX shown in FIG. 17;

FIG. 20 shows, with partial cutaway, a perspective view illustrating a conventional electric actuator; and

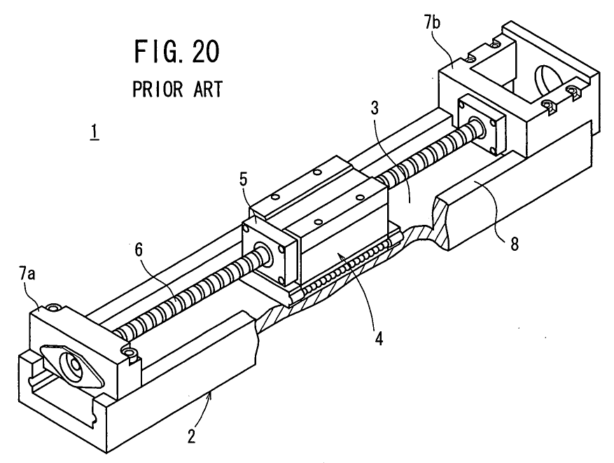

FIG. 21 shows an exploded perspective view illustrating the conventional electric actuator shown in FIG. 20.

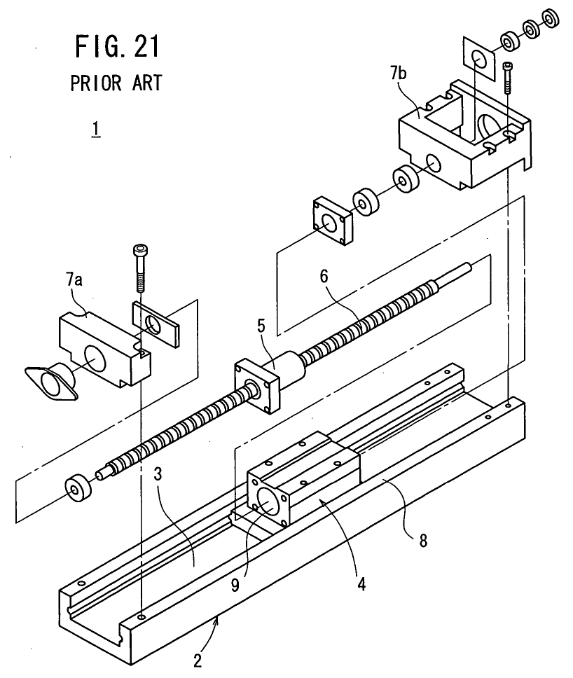

### DESCRIPTION OF THE PREFERRED EMBODIMENTS

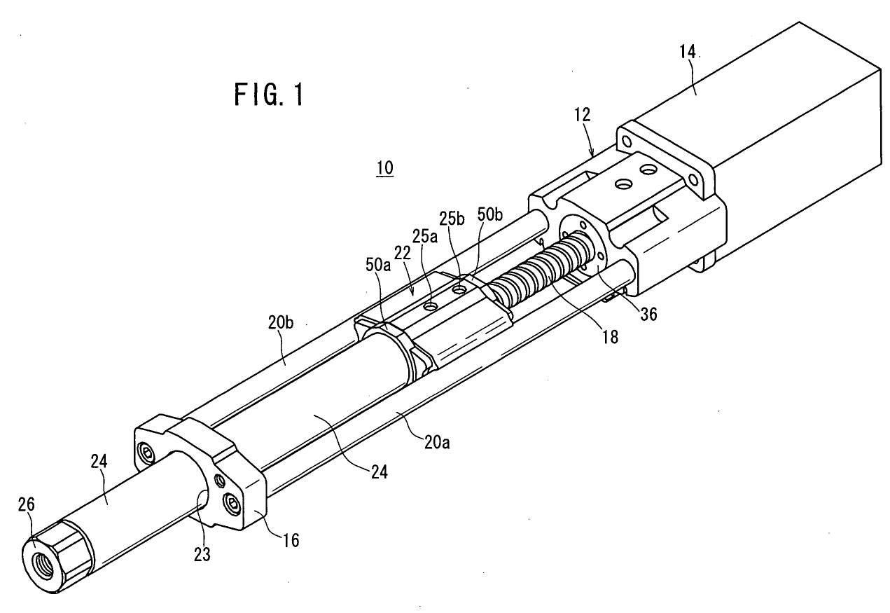

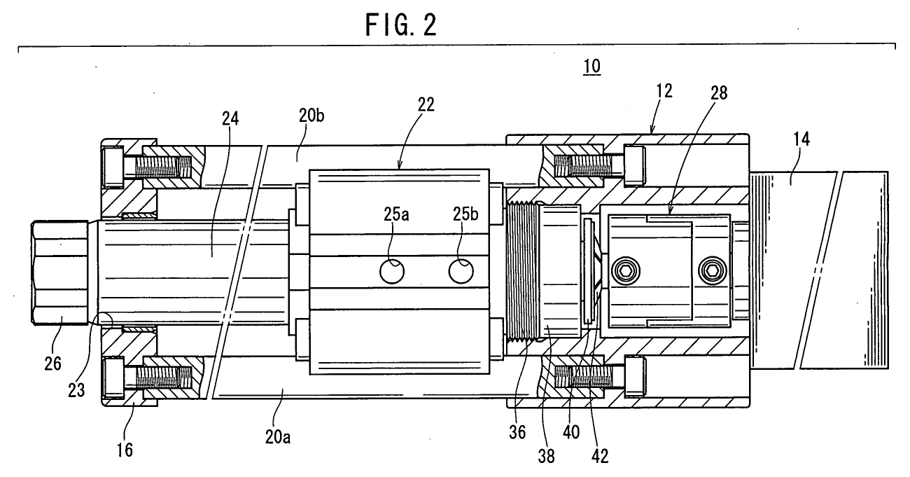

With reference to FIGS. 1 to 3, reference numeral 10 indicates an electric actuator according to an embodiment of the present invention.

The electric actuator 10 comprises a housing 12 having a substantially flat block member, a rotary driving source 14 which is connected to one end of the housing 12, a rod cover (end block) 16 which is separated from the housing 12 at a predetermined distance, and which is disposed on the opposite side of the rotary driving source 14, and a feed screw shaft (driving force-transmitting shaft) 18 which transmits the rotary driving force of the rotary driving source 14 via a coupling member.

The electric actuator 10 further comprises a pair of guide rods 20a, 20b, a piston 22, a hollow cylindrical piston rod 24, and a socket 26. The guide rods 20a, 20b are arranged in parallel to one another with the feed screw shaft 18 disposed in-between. Each of the guide rods 20a, 20b has one end connected to the housing 12 and the other end connected to the rod cover 16. The piston 22 comprises a feed nut which is moves along the pair of guide rods 20a, 20b under the action of the rotary driving force transmitted by the feed screw shaft 18. The piston rod 24 penetrates through a hole 23 of the rod cover 16 and moves back and forth integrally with the piston 22. The socket 26 is installed to the forward end of the piston rod 24 to close the hole.

The piston 22 and the piston rod 24 function as displaceable members.

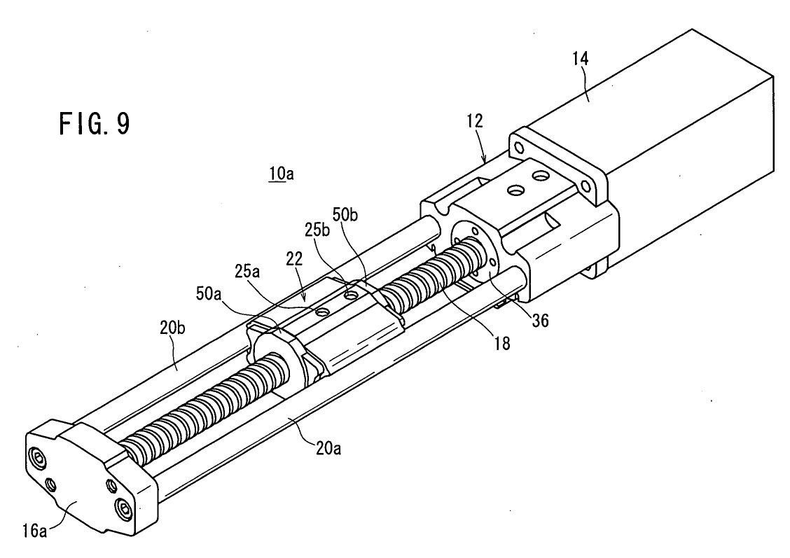

In this arrangement, when the piston rod 24 is removed from the piston 22 to use another rod cover 16a in which the hole 23 for the penetration of the piston rod 24 is closed, it is possible to change the rod type electric actuator to a slide table type electric actuator 10a which is used to connect an unillustrated slide table to the piston 22 (see FIG. 9). Therefore, the electric actuator can change from the rod type, in which the piston rod 24 expands and contracts from the rod cover 16 toward the outside, to the slide table type, in which the slide table (not shown) connected to the piston 22 moves via a pair of attachment holes 25a, 25b. Further, the rod type electric actuator and the slide table type electric actuator are easily interchangeable.

As for the surface treatment for the feed screw shaft 18, it is preferable to apply an electroless nickel plating treatment.

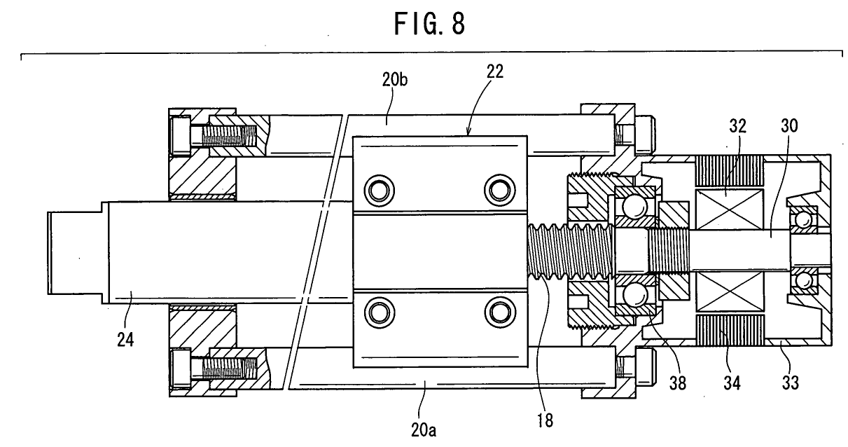

As shown in FIG. 8, the feed screw shaft 18 may be combined with a motor shaft 30 without using any coupling member 28. In FIG. 8, reference numeral 32 indicates a rotor which is rotatable with the feed screw shaft 18, and reference numeral 34 indicates a stator coil which is fixed to a motor housing 33.

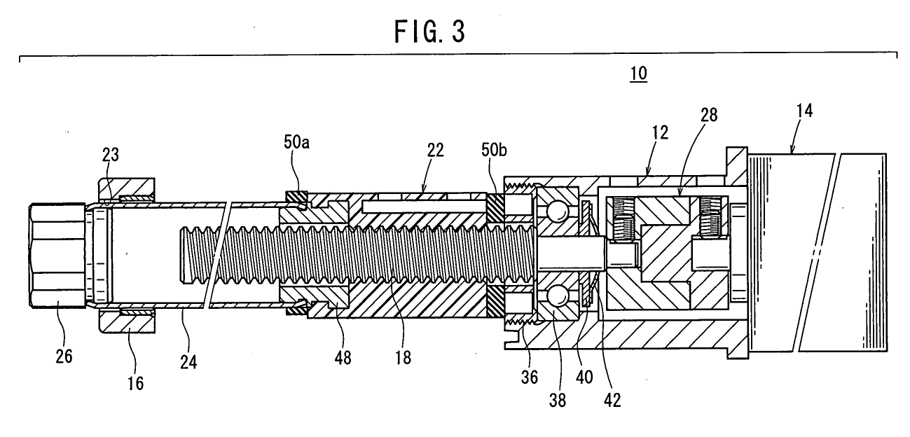

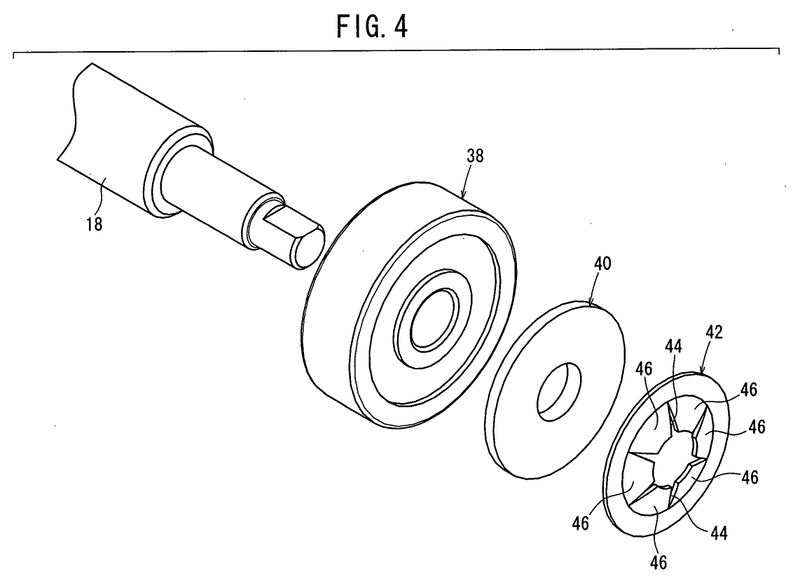

As shown in FIGS. 3 and 4, a bearing holder 36, a bearing 38, a disk-shaped spacer 40, and a fastening member 42 are installed to an end of the feed screw shaft 18 which is near the coupling member 28. The bearing holder 36 is fixed to the housing 12 by the aid of a thread engraved on the outer circumferential surface. As shown in FIG. 4, the fastening member 42 has a plurality of slits 44 which are formed radially. A plurality of tongues 46, which elasticity work in only one direction, are formed circumferentially.

In this arrangement, the bearing 38 and the spacer 40 are inserted into the end of the feed screw shaft 18, and then the fastening member 42 is pressed along the end of the feed screw shaft 18. Accordingly, the tongues 46 encircle and fasten the end of the feed screw shaft 18.

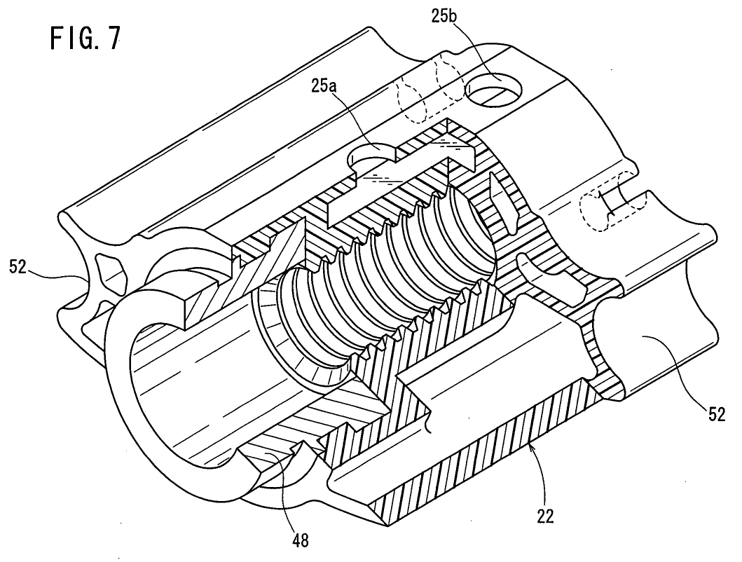

As shown in FIG. 7, the piston 22, for example, is integrally formed of resin in which a cylindrical member 48 of a metal material such as aluminum is inserted. The piston 22 and the piston rod 24 may be tightly connected to one another (see FIG. 3) by using, for example, the process of screwing, caulking, shrinkage fit, or cooling fit. Annular dampers 50a, 50b, each of which is formed of, for example, an elastic material such as urethane rubber, are installed to both ends of the piston 22 in the axial direction.

When producing the piston 22, it is preferable to use a material containing nodular or spheroidal graphite and carbon fiber in a resin material such as PBT or polyacetal. The nodular graphite makes it possible to improve abrasion resistance characteristics by lowering the coefficient of dynamic friction. The carbon fiber makes it possible to retain the mechanical strength at a minimum required strength by enhancing the dimensional stability by preventing any deformation, which would be otherwise be caused by the heat generated upon sliding movement.

The following values are required for the mechanical characteristics.
Maximum tensile strength: not more than 57 MPa
Breaking elongation: 2 to 5%
Maximum bending strength: 80 to 95 MPa
Bend elastic constant: 33 J/m

As for the grease, it is preferable to use those of aromatic diurea compound, or olefinic lithium soap with a kinematic viscosity of 100 cs. These compounds are compatible with the materials as described above, and it is possible to effectively increase the duration of the traveling motion.

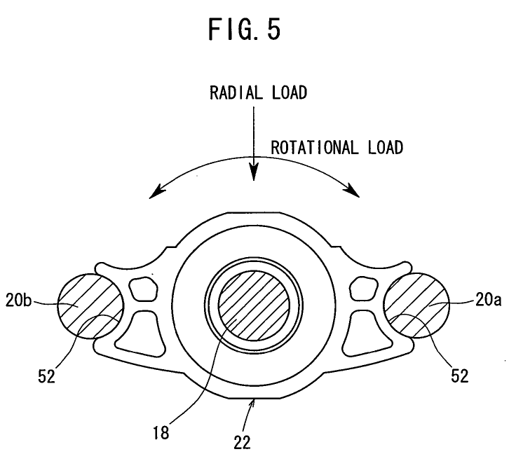

Guide sections 52 (see FIGS. 5 and 7), which have substantially circular arc-shaped cross sections to make line contact with the outer circumferential surfaces of the guide rods 20a, 20b, are formed on both side surfaces of the piston 22, whish is disposed substantially perpendicular to the axis. The piston 22 is interposed between the pair of parallel guide rods 20a, 20b. Therefore, as shown in FIG. 5, when a load in the radial direction (radial load) is applied to the piston 22, or when a load in the rotational direction (rotational load) is applied to the piston 22, the load is absorbed by the pair of guide rods 20a, 20b. The pair of guide rods 20a, 20b also function as a rotation stopper for the load in the rotational direction.

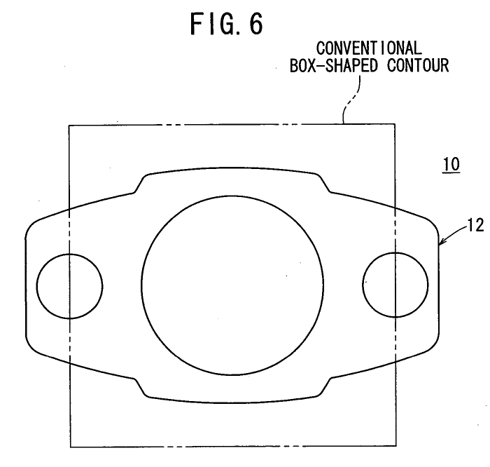

All of the housing 12, the piston 22, and the rod cover 16 are formed to have a similar flat shape when viewed from the axial direction. The dimension in the height direction is decreased as compared with the conventional box-shaped contour (see FIG. 6).

The electric actuator 10 according to the embodiment of the present invention is basically constructed as described above. Next, its operation, function, and effect will be explained.

When an unillustrated power source is energized, the rotary driving force of the rotary driving source 14 is transmitted to the feed screw shaft 18 via the coupling member 28. The feed screw shaft 18, which is rotated in the predetermined direction, is screwed into the screw hole of the piston 22 as the feed nut. Accordingly, the piston 22 is displaced in the axial direction integrally with the piston rod 24 under the guiding action of the pair of guide rods 20a, 20b. When the polarity of the current flowing through the rotary driving source 14 is reversed, the piston 22 and the piston rod 24 can be operated in the direction opposite to the above.

In the embodiment of the present invention, the actuator is driven by a motor, which used in the same way as using an air cylinder, even in an environment in which there is no compressed air or compressed air cannot be used.

In this case, the phrase “used in the same way as using an air cylinder” refers to, for example, the fact that the actuator is driven on the basis of the ON/OFF control, no controller is required, abutment operation can be performed for the piston 22, the actuator can be driven without any sensor for detecting the position of the piston, and ability to control the speed and the thrust force of the piston 22 and the piston rod 24.

In the embodiment of the present invention, the rigid body 2 used in the conventional technique is unnecessary, and the pair of parallel guide rods 20a, 20b are used to secure predetermined rigidity. Accordingly, production cost can be reduced by decreasing the number of parts, and the weight of the electric actuator is lightened.

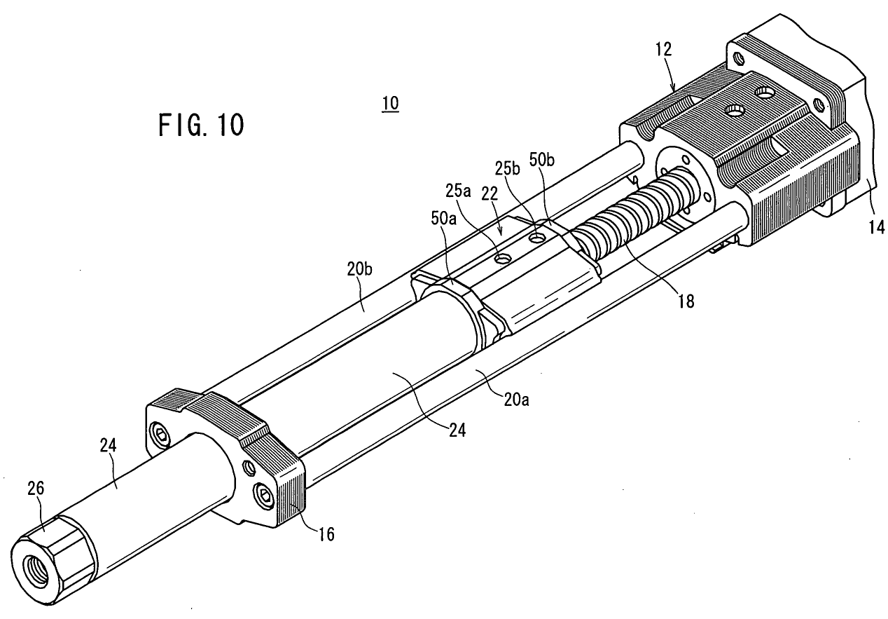

The method for producing the housing 12 and the rod cover 16 may include, for example, integrated forming with aluminum die-casting, resin forming, and sheet metal deep drawing. Alternatively, it is preferable to use, for example, stacked steel plates integrally formed by staking a plurality of steel plates as shown in FIG. 10.

For the rotary driving source 14, it is preferable to use, for example, a DC brush-equipped motor, a DC brushless motor, a stepping motor, or an AC servomotor.

For the feed screw shaft 18, it is preferable to use, for example, a slide screw shaft made of resin, a slide screw shaft made of metal, or a ball screw shaft. Alternatively, it is also preferable to use, for example, a timing belt run over pulleys.

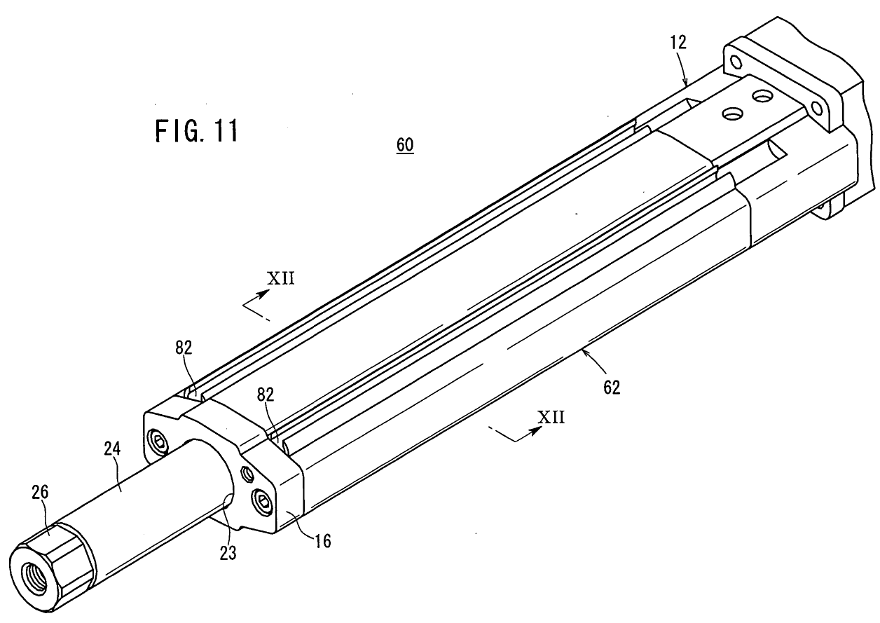

Next, an electric actuator according to another embodiment installed with a cover member is shown in FIGS. 11 to 16. The same constitutive components or parts as those of the electric actuator 10 shown in FIG. 1 are -designated by the same reference numerals, any detailed explanation of which will be omitted.

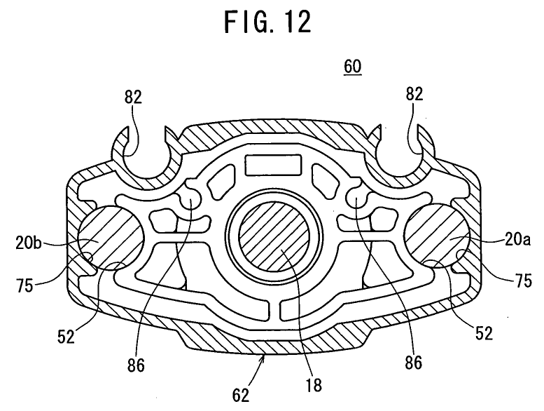

In an electric actuator 60 shown in FIGS. 11 and 12, for example, the feed screw shaft 18, the piston 22, and the guide rods 20a, 20b are not exposed. The electric actuator 60 comprises a lengthy cover member 62 which covers the entire structure including, for example, the feed screw shaft 18, the piston 22, and the guide rods 20a, 20b. It is preferable that the rod type actuator is used for the electric actuator 60.

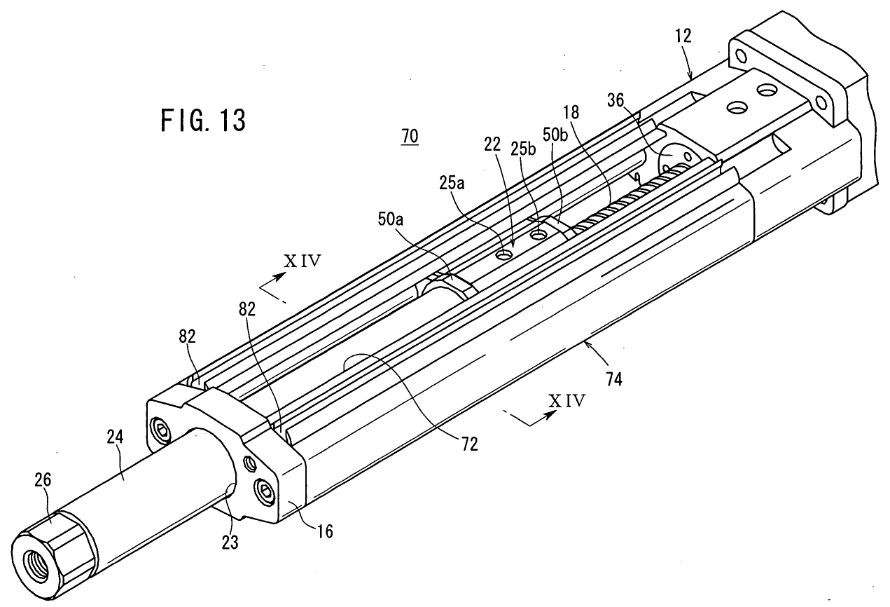

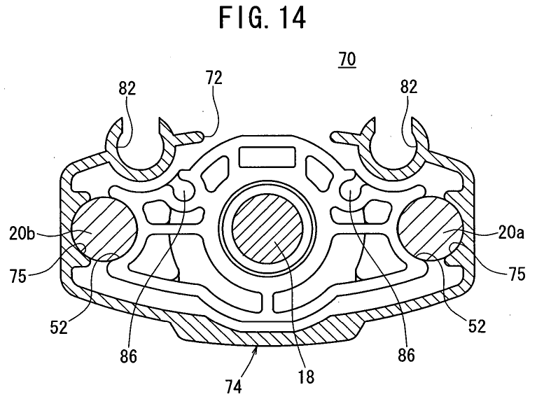

An electric actuator 70 shown in FIGS. 13 and 14 includes a cover member 74 which has an opening 72 formed on the upper surface and along the axial direction, in which parts of the feed screw shaft 18 and the piston 22 are exposed through the opening 72. It is preferable to use the slide table type actuator for the electric actuator 70. As shown in FIGS. 12 and 14, a pair of circular arc-shaped surface sections 75, which face the guides 52 of the piston 22 and which are engaged with the pair of guide rods 20a, 20b, are formed on the inner wall surface of the cover member 62, 74.

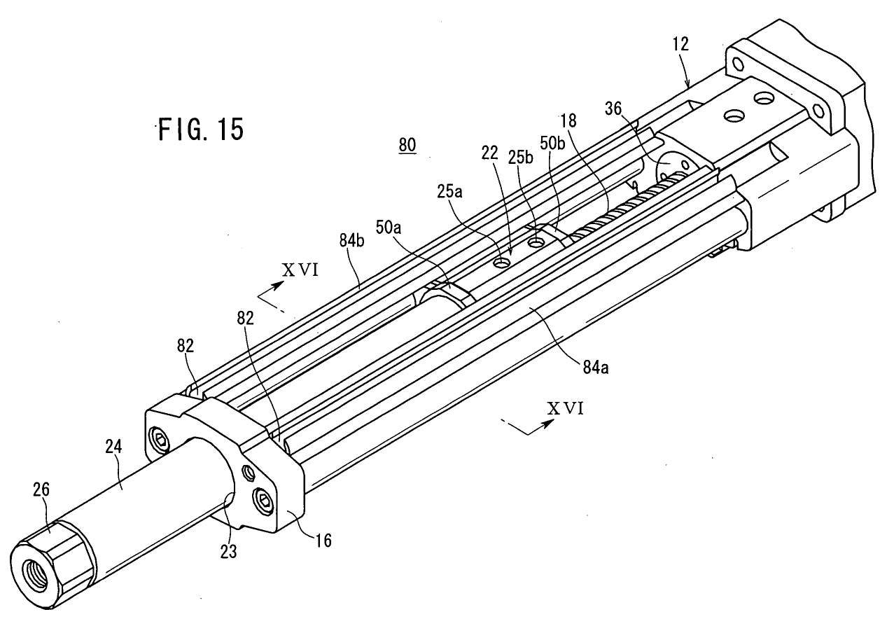

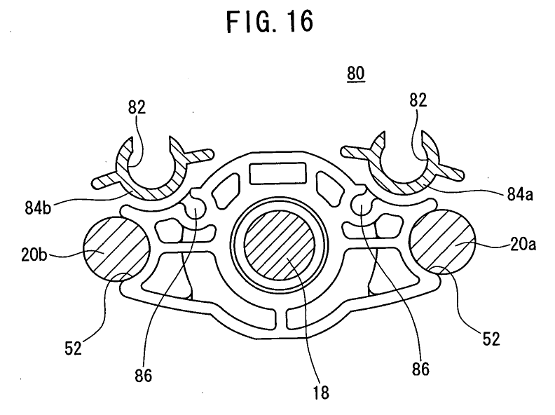

An electric actuator 80 shown in FIGS. 15 and 16 comprises a pair of sensor rails 84a, 84b bridging between the housing 12 and the rod cover 16, and which are formed with sensor attachment grooves 82. Either the rod type or the slide table type actuator can be used as the electric actuator 80.

The pair of sensor attachment grooves 82 are formed on the cover members 62, 74 and the sensor rails 84a, 84b. A variety of sensors including, for example, proximity sensors and photomicrosensors are installed to the sensor attachment grooves 82. In FIGS. 12, 14, and 16, reference numeral 86 indicates a magnet. The position of the piston 22 is detected by using the unillustrated sensor installed to the sensor attachment groove 82, which detects the magnetic field of the magnet 86.

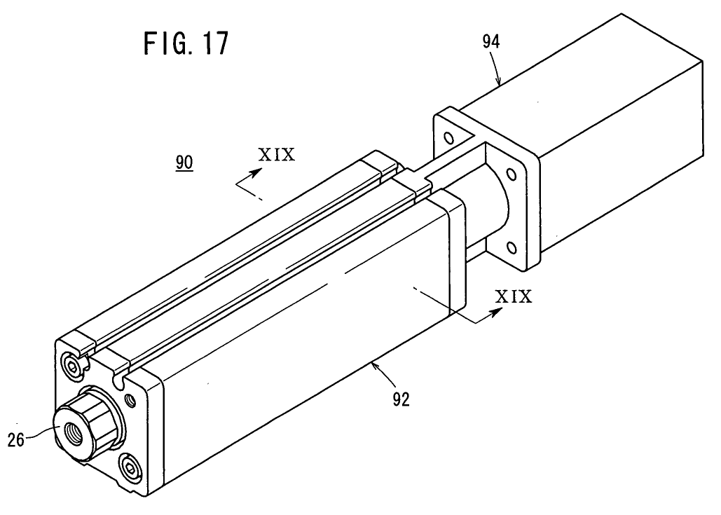

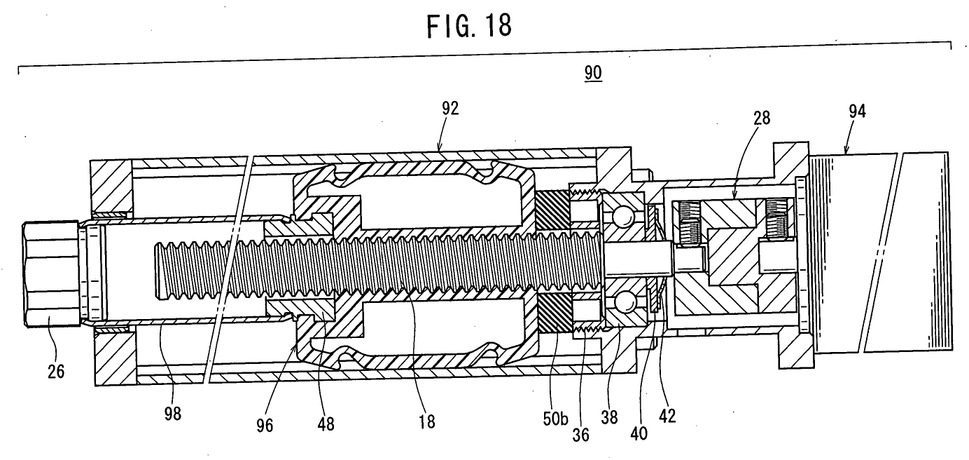

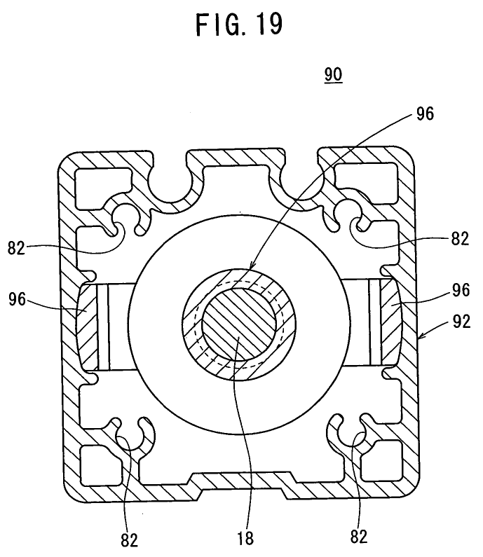

Next, an electric actuator 90 having a rectangular box-shaped frame 92 is shown in FIGS. 17 to 19.

The electric actuator 90 comprises a frame 92 which has four sensor attachment grooves 82 formed therein which extend along the axial direction, a feed screw shaft 18 which transmits the rotary driving force of a rotary driving source 94, a feed nut section 96 which is screwed with the feed screw shaft 18, and a rod section 98 which is connected to the feed nut section 96 and which has a part exposed outside of the frame 92.

Although certain preferred embodiments of the present invention have been shown and described in detail, it should be understood that various changes and modifications may be made therein without departing from the scope of the appended claims.

1. An electric actuator comprising:
a housing which is flatly shaped;
a rotary driving source which is connected to said housing;
a driving force-transmitting shaft which allows a displaceable member to make rectilinear reciprocating motion by converting a rotary driving force of said rotary driving source into rectilinear motion to be transmitted to said displaceable member;
an end block separated from said housing at a predetermined distance in an axial direction; and
a pair of guide rods each of which has one end connected to said end block and the other end connected to said housing, which are parallel to one another with said displaceable member intervening therebetween, and which make sliding contact with guide sections of said displaceable member to guide said displaceable member thereby.

2. The electric actuator according to claim 1, wherein:
said driving force-transmitting shaft comprises a feed screw shaft which is connected to a drive shaft of said rotary driving source for rotation; and
said displaceable member comprises a piston which is displaceable along said pair of guide rods under an action of said rotary driving force transmitted via said feed screw shaft, and a piston rod which moves back and forth integrally with said piston.

3. The electric actuator according to claim 1, wherein:
said driving force-transmitting shaft comprises a feed screw shaft which is connected to a drive shaft of said rotary driving source for rotation;
said displaceable member includes a piston which is displaceable along said pair of guide rods under an action of said rotary driving force transmitted via said feed screw shaft, and a piston rod which moves back and forth integrally with said piston;
said end block includes a rod cover formed with a hole through which said piston rod penetrates, and a rod cover in which said hole is closed; and
by selecting any one of said rod covers, said electric actuator is interchangeable between a rod type in which said piston rod expands and shrinks through said hole of said rod cover, and a slide table type in which said piston rod is removed and said rod cover is installed to said ends of said pair of guide rods so that only said piston is displaceable along said guide rods.

4. The electric actuator according to claim 2, wherein a bearing holder, a bearing, a spacer, and a fastening member are installed to an end of said feed screw shaft, and said fastening member is provided with a plurality of slits which extend radially, and a plurality of tongues each of which has elasticity working in only one direction.

5. The electric actuator according to claim 2, wherein said piston is integrally formed of resin, in which a cylindrical member of a metal material is inserted.

6. The electric actuator according to claim 2, wherein all of said housing, said piston, and said end block have a similar flat shape when viewed from said axial direction.

7. The electric actuator according to claim 1, wherein each of said housing and said end block is integrally formed by stacking a plurality of steel plates.

8. The electric actuator according to claim 1, further comprising a cover member which covers an entire structure including said housing, said driving force-transmitting shaft, said displaceable member, and said pair of guide rods.

9. The electric actuator according to claim 1, further comprising a cover member which has an opening formed through an upper surface in said axial direction wherein parts of said driving force-transmitting shaft and said displaceable member are exposed through said opening.

10. The electric actuator according to claim 1, further comprising a pair of sensor rails, said sensor rails bridging between said housing and said end block, each of said sensor rails having a sensor attachment groove.
